(19) United States
(12) Patent Application Publication
(10) Pub. No.: US 2010/0084880 A1
(43) Pub. Date: Apr. 8, 2010

(54) Disposable Waste Collecton Device

(76) Inventors: Frank Avilez, Los Angeles, CA (US); Anna Avilez, Los Angeles, CA (US)

Correspondence Address: LAW OFFICES OF J.F. LEE, 17800 CASTLETON STREET, SUITE 383, CITY OF INDUSTRY, CA, 91748, US

(21) Appl. No.: 12/245,890

(22) Filed: Oct. 6, 2008

(51) Int. Cl. A01K 29/00

(52) U.S. Cl. 294/1.3

(57) ABSTRACT

Present invention of a disposable waste collection device provides a glove-type bagging portion where the fingers' maneuvering is not affected. With the use of an inverted zipper mechanism, collected waste material such as dog poop can be easily sealed by simple one hand operation. A layer of liquid-absorbing material can be added to the outer surface of the place where hand is grabbing the waste material, to aid the ease of dealing with mushy and wet object. The use of biodegradable material for the bag and the zipper mechanism will further assist the environmental friendliness of present invention.

### FIELD AND BACKGROUND OF PRESENT INVENTION

The problem of picking up pet litter, such as dog poops, usually involves the use of a plastic bag, or some rumpled newspaper, along with tissue paper for people to clean their hands. When people want to take their pets out, such as walking their dogs in their neighborhood, oftentimes they have to scramble for something (newspaper, paper towel, etc) and the result is mostly less than ideal. There is no simple and convenient gadget for pet lovers to easily clean up after their pets and keep things nice and tidy.

Present invention provides an easy to use and environmental friendly way of picking up litter or waste, so that the waste collected need no further transportation or transmission and the users can very easily keep themselves clean.

### OBJECT AND SUMMARY OF THE PRESENT INVENTION

A main object of the present invention is to provide a bag with a defined hand-shaped contour area wherein people can insert their hand into the bag and maneuver for grabbing and picking up objects. After the waste material is grabbed and held in hand, the hand is then pulled out from the opening of the bag.

An inverted zipper mechanism is located at the opening. When the hand, along is pulled out of the bag with the waste material left inside, the zipper mechanism will be inverted back to the normal working status and, with the help of the other hand, close the bag, while leaving the collected waste material inside.

The bag can be made from the everyday plastic bag having a zipper mechanism at the opening. Certainly, the bag can be made from environmentally friendly material such as some type of biodegradable material.

To make the device of present invention, the prior art zipper-bag is first inverted; that is, it is flipped inside out. And then a glove-type hand-shaped contour is formed, either by heat-stamping the surface, so that the stamped part melt together, joining the two sides of the bag, forming a glove shape chamber inside, or by sewing to form the glove type chamber.

Containment of waste material collected by using device of present invention can be further improved when a layer of cotton, or other liquid-absorbing material is overlaid on the outside surface of the hand-shaped contour, so that when the device is maneuvered to pick up animal waste, or even used in a medical setting, the device achieves a better function of removing mushy material.

### BRIEF DESCRIPTION OF THE DRAWINGS

FIG. 1 is the front view of the device of present invention, showing the hand-shaped contour made to the bag.

FIG. 2 shows the zipper portion of the bag after collection of waste material, where the zipper is in the non-inverted stated.

FIG. 3 shows that side view of a zipper in the alternative form of one side being a solid ridge, the other side containing a corresponding groove. A layer of liquid-absorbing material is also shown.

### DETAILED DESCRIPTION OF THE PREFERRED EMBODIMENT

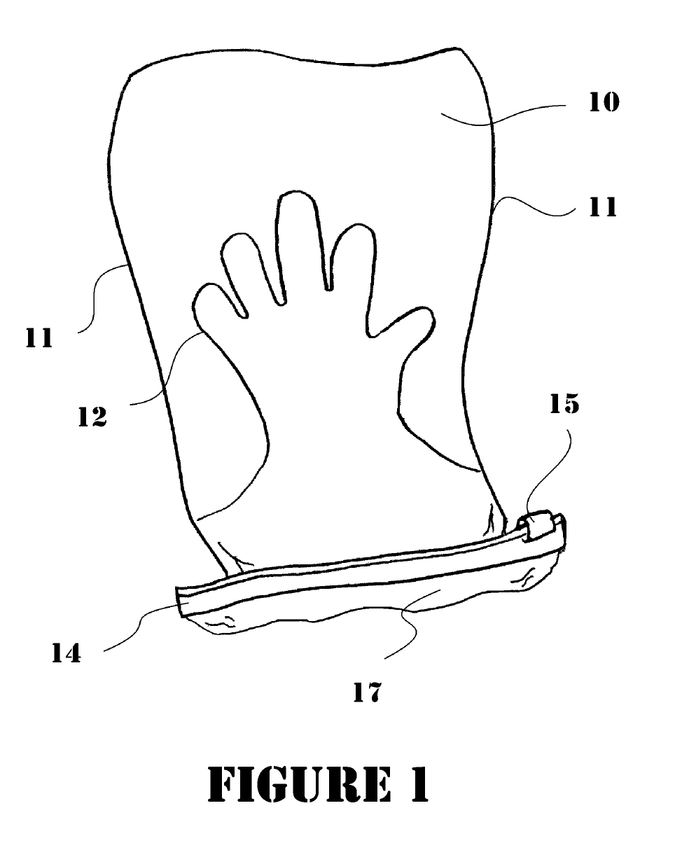

Referring to FIG. 1, a bag 10 for the waste collection device is shown. The bag 10 has two sides that are joined along edges 11 and has an opening 18. A hand shape is formed by some means to define an area similar to the shape of a work glove, allowing people to insert their hand and have the ability to maneuver their fingers inside the chamber as defined by the contour line 12.

The contour line 12 can be made by heat-stamping, or sewing together the two flat (and flexible) sides of the bag 10, forming the inner chamber of the glove for hand/fingers to be inserted. This heat-stamping or sewing, or other means, needs no disclosure in present invention and forms no part of the claim herein, except to the extent it is combined with the remaining disclosure of present invention.

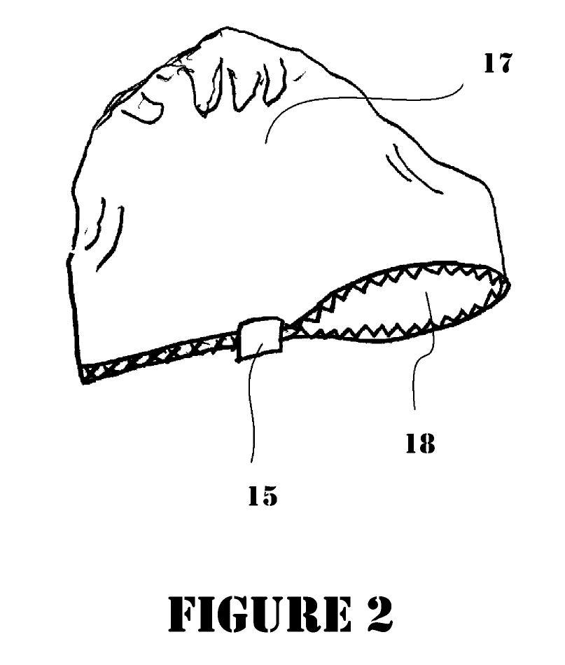

Note that the zipper 14 is in an inverted state for the ready-to-use device made pursuant to the disclosure herein. A portion of the inner side 17 of the bag 10 will be exposed as shown in FIG. 1, near the zipper 14. This allows a person's hand, when inserted into present device and after getting hold of waste material in the palm area, to be pulled out and back through the opening 18, the bag itself can then be closed by pulling the zipper pull 15 to close the opening 18, at which time, the bag 10 and zipper 14 are in the non-inverted state, as shown in FIG. 2, and the waste material is securely wrapped inside the bag and can be disposed off properly.

The material of bag 10, zipper 14 and zipper pull 15 can be made from biodegradable material to make the claimed device more environmental friendly.

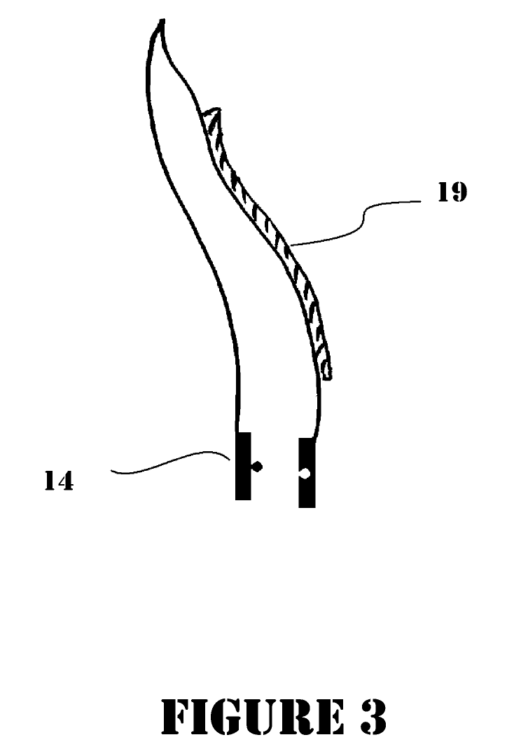

Additionally, a layer of liquid-absorbing material 19 can be overlaid generally on top of the surface where the hand contour line 12, as shown by the side view in FIG. 3, so that the use of present device is made more versatile to cope of waste object that are somewhat mushy and may also be used in medical waste handling.

The thickness of the material used in present invention is not really critical, as long as the flexibility allow for reasonable movement and maneuvering of people's hand and fingers for grabbing objects and pulling out from the bag 10 and for zipping the bag 10 close.

What is claimed is:

1. A disposable waste collection device, comprising:
A bag having two sides joined along edges and an opening with an inverted zipper mechanism; and,
A contour line joining the two sides of said bag and forming a hand shape so that the inner space of said bag becomes a maneuverable glove-type chamber for receiving a hand.

2. The device of claim 1 wherein the hand-shape contour line is made by means of heat to melt the part of the material of the bag from the two sides.

3. The device of claim 1 wherein the hand-shaped contour line is made by sewing the part of the material of the bag from the two sides.

4. The device of claim 1 wherein the material for the bag and the zipper mechanism are made from biodegradable material.

5. The device of claim 1, wherein the zipper mechanism can be in the form of one side having a long ridge, while the other side having a corresponding groove to receive the ridge.

6. The device of claim 1, wherein the zipper mechanism can be in the form of two strips having corresponding meshing teeth structure.

7. The device of claim 1, further comprising a layer of liquid-absorbing material covering the outside surface of the contour-shaped hand area.
